(19) United States
(12) Patent Application Publication
(10) Pub. No.: US 2006/0229960 A1
(43) Pub. Date: Oct. 12, 2006

(54) System and method for creating recurrent yield monetary asset based financial instrument derivatives

(76) Inventor: Harry Edelson, Woodcliff Lake, NJ (US)

Correspondence Address: PATTON BOGGS LLP, 2550 M STREET NW, WASHINGTON, DC, 20037-1350, US

(21) Appl. No.: 11/101,436

(22) Filed: Apr. 8, 2005

(51) Int. Cl. G06Q 40/00; G06F 7/00; G06F 17/00

(52) U.S. Cl. 705/35; 707/100

(57) ABSTRACT

The system and method for creating recurrent yield monetary asset based financial instrument derivatives operates with existing telecommunications networks, including voice, data, and internet protocol to provide financial instrument derivatives that are based on recurrent yield monetary assets. A rollup entity communicates with present resources that own or hold recurrent yield monetary assets to transfer the recurrent yield monetary assets to the rollup entity in exchange for financial derivative instruments having a favorable price to earnings ratio. The rollup entity deposits these recurrent yield monetary assets and invest portions of them with an investment entity to further grow the asset base of the rollup entity.

### FIELD OF THE INVENTION

This invention relates broadly to the field of creating financial instruments, and more particularly relates to financial instrument derivatives of rollups of recurrent yield monetary based assets.

### PROBLEM

It is a problem in the field of acquisitions, particularly rollups, to perform as planned in a consistent manner and to provide investors with consistent favorable returns on their investments. Rollups are a planned and executed acquisition of many companies that exist in an highly fragmented industry that ultimately come under the control of a strong management team that strives to build a large, dominant, and profitable franchise. Smaller companies may be valued at much lower multiples of earnings than larger companies, because of their limited geographic coverage, name recognition, product lines, and lack of ability to spread fixed costs over a larger revenue base. Rollup consolidators strive to build a larger company out of the group of acquired smaller companies, and thus reap the financial rewards associated with holding financial instruments that yield higher multiples of earnings. Investors wishing to reap these benefits, invest capital into rollups in exchange for some equity instrument, such as stock, that yields favorable multiple of earnings greater than otherwise would be yielded with the same investment in smaller companies. The invested capital is then used by the rollup consolidator to acquire additional companies thereby further growing the franchise and the benefits of economies of scale. However, many problems arise with rollups and their related financial instruments.

One such problem associated with conventional rollups is the high costs associated with acquiring these smaller companies. Financing a rollup usually requires commitments from multiple sources of capital. These sources of capital come with significant associated costs that vary depending on the perceived strength of the rollup entity and whether or not there is precedent in the industry to buy and build in a particular industry.

Another problem is in altering the modus operandi of the acquired owner-operated companies and molding them to operate as a large and cohesive company instead of a loose band of disparate but related confederation of businesses.

Another problem is that many incentives, including stock options are granted to owner-operators of the acquired business, thus few incentives exist or are available to entice new professional managers to come aboard to assist with improving the rollups performance. Further, in an effort to measure the performance of these owners-operators of the acquired businesses, the businesses are evaluated individually, which undercuts the integration of acquired business into the rollup company. Also, having been acquired, these owner-operators may believe that the success of each acquired business is now the responsibility of the rollup company's central management. In addition, many promises, such as continued autonomy or independence from the central rollup management team, are made to the acquired businesses during the acquisition phase that act as inhibitors to create a cohesive rollup company.

Yet another problem is that each acquired business has their own set of administrative processes, such as accounting, billing, financial reporting, and the like. This presents the rollup company with the task of instilling a common set of processes among a large number of disparate businesses.

These problems effect the equity instruments, such as stocks, derivatives, indexes, and the like that flow from the rollup company. These problems and uncertainties ultimately effect the perception of investors regarding the success of the rollup and, thus suppress the price of these financial instruments, which in turn inhibits a rollup entity from achieving optimal high earning per share values. Therefore, there is a need for a financial instrument that is based on a rollup that is more stable, prosperous, efficient, and that does not possess problems associated with conventional rollups.

### SOLUTION

The above-described problems are solved and a technical advance is achieved in the art by the system and method for creating recurrent yield monetary asset based financial instruments derivatives. The system and method for creating recurrent yield monetary asset based financial instruments derivatives acquires individual sources of recurrent yield monetary assets such as royalties and portions of guaranteed salaries and exchanges them for equity financial instruments, such as stock, that are derivative of the system. As the system and method for creating recurrent yield monetary asset based financial instruments derivatives continues to acquire additional individual sources of recurrent yield monetary asset base grows accordingly. In addition, its asset base is further grown through investments, which further increases the value of the asset base of the system and accordingly the value of the stock that it issues.

The system avoids the costs and expenses associated with acquiring owner-operated businesses of conventional rollups by acquiring recurrent yield monetary asset streams such as royalties and salaries. This alleviates the problems associated with having to seek and incur the costs associated with traditional acquisition financing. The present system does not require taking on additional debt as required by conventional rollups to acquire additional assets. In addition, this further alleviates the problems associated with altering the modus operandi of the acquired owner-operated companies and molding them into a large and cohesive confederation of businesses.

The system and method for creating recurrent yield monetary asset based financial instruments derivatives further solves the problems associated with granting rollup based stock and stock options to the owner-operators in exchange for the acquired business. Because the system and method for creating recurrent yield monetary asset based financial instruments derivatives does not acquire conventional owner-operated businesses, it does not expend resources typically required by conventional rollups to bring in new professional managers in light of the stock options that have been previously granted to the owner-operators of these acquired businesses. It further saves resources by not having to motivate these owner-operators to accept responsibility for the goal of success in light of the management being shifted to the rollup company's central management.

The system and method for creating recurrent yield monetary asset based financial derivative instruments further solves the problem of being laden with a plethora of different administrative processes, due to the fact that the assets that it is acquiring is revenue from recurrent yield monetary asset sources and not individual businesses. Thus there is no need for the instilling a set of common processes among a large number of disparate businesses.

Because the system and method for creating recurrent yield monetary asset based financial instruments derivatives does not have these expenses and assimilation problems it is capable of producing significantly larger margins of profit. This adds to the value of the rollup company and the management team and leads to investor confidence that increases the price earnings ratio of the stock. Such a system can take recurrent yield monetary assets and issue financial derivative instruments that will be ultimately valued at 15-25x the value of the cash value of the assets. The acquisition of streams of royalties or salaries entail none of the problems outlined earlier, and instead feature stable revenue streams, large gross margins, very high growth rates, and extremely large cash flows which will be channeled into an internally run hedge fund or fund of funds within the system. The system provides software, hardware, and processes that achieve a much higher profit potential than conventional rollups.

In one aspect the system and method for creating recurrent yield monetary asset based financial instruments derivatives is a private system whose members comprise the shareholders whom have contributed recurrent yield monetary assets to the system. Another aspect of the system and method for creating recurrent yield monetary asset based financial instruments derivatives is a publicly traded financial derivative whose financial instruments are traded openly, such as on an index or exchange.

Thus, the system and method for creating recurrent yield monetary asset based financial instruments derivatives facilitates the beneficial implementation of derivative transactions and related hedging strategies. Because the system and method for creating recurrent yield monetary asset based financial instruments derivatives is an economically and financially independent entity, the providers of the recurrent yield monetary assets limit their exposure to problems associated with conventional rollups and can profit from the derivative transactions and investments that the rollup enters into without incurring the negative ramifications of other forms of conventional rollups. It is believed that this system and method for creating recurrent yield monetary asset based financial instruments derivatives provides a previously unavailable financial arrangement for individuals, groups, businesses, and corporations that have recurrent yield monetary assets (such as, for example oil and music royalties) for engaging in derivative transactions based on rollups that they might otherwise avoid because of the potential impacts on their financial capital.

### SUMMARY

The invention provides for a computer-implemented system for creating financial instrument derivatives based on recurrent yield monetary assets having an asset value from a recurrent yield monetary asset resource, including: a rollup entity, the rollup entity comprising: a means for transferring from the recurrent yield monetary asset resource the at least one of the recurrent yield monetary assets; a means for depositing at least one of the recurrent yield monetary assets into a rollup entity earnings account; a means for calculating, responsive to depositing of the at least one recurrent yield monetary asset, at least one of the group consisting of a cash value and a number of shares of the financial instrument derivatives based on the asset value; a means for issuing the calculated number of shares of the financial derivative instruments to the at least one recurrent yield monetary asset resource; a database located for storing information and data representative of the at least one recurrent yield monetary asset and the financial derivative instruments; and a means for communicating between the recurrent yield monetary asset resources and the rollup entity for transmitting the information and the data related to the at least one recurrent yield monetary asset.

Preferably, the computer-implemented system further includes a means for investing a portion of the rollup entity earnings account in a rollup entity investment. Preferably, the communicating means is selected from the group consisting of World Wide Web, Internet, intranet, and telephony. Preferably, the communicating means further includes an internet-enabled interface, the internet-enabled interface permitting the at least one recurrent yield monetary asset resource and the rollup entity to communicate to each other by way of the Internet. Preferably, the calculating means calculates a price to earnings multiple for the financial derivative instruments. Preferably, the communicating means further includes encrypted data transfer means for securely transmitting the information and the data between the recurrent yield monetary asset resource and the rollup entity.

These and other features, aspects, and advantages of the present invention will become better understood with regard to the following description, appended claims, and accompanying drawings.

### BRIEF DESCRIPTION OF THE DRAWINGS

FIG. 1 illustrates in block diagram form the overall architecture of one embodiment of a recurrent yield monetary asset based derivatives system of the present invention;

FIG. 2 illustrates in block diagram form one embodiment of a recurrent yield monetary asset based derivatives system of the present invention;

FIG. 3 illustrates in block diagram form the embodiment of FIG. 2 depicting the recurrent yield monetary assets transferred to the rollup entity; and

FIG. 4 illustrates process flow diagram for a recurrent yield monetary asset based derivatives system of FIG. 1.

### DETAILED DESCRIPTION OF THE DRAWINGS

In accordance with the present system and method for creating recurrent yield monetary asset based financial instruments derivatives (“recurrent yield monetary asset based derivatives system”), the recurrent yield monetary asset based derivatives system acquires revenue streams and monetary assets (“recurrent yield monetary assets”) from a variety of sources, including royalties, salaries, royalty-type streams of revenue, publishing, or other such continuous or recurrent revenue based streams. These royalties can be based on the use of many different types of property, including copyrights, trademarks, patents, oil-revenue royalties, movies, videos, publishing, and the like. Financial equity instruments (“financial derivative instruments”), such as stocks, are exchanged for each revenue stream acquired by the recurrent yield monetary asset based derivatives system. Financial derivative instruments generally mean a financial instrument that is based on some underlying cash product. Financial derivative instruments can include options, futures, forward contracts, and any other available and suitable derivative financial instruments.

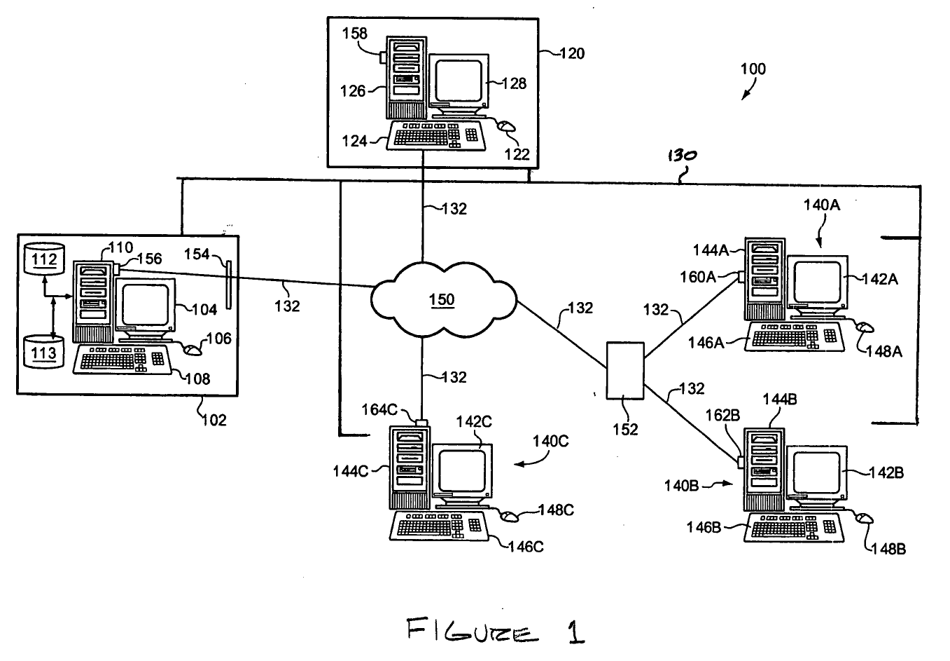

FIG. 1 illustrates a typical system environment in which the present recurrent yield monetary asset based derivatives system is operational. This system architecture is simply illustrative of a typical configuration of computer processing resources and telephone communications systems and is intended to illustrate the issues that are encountered in the acquisition of recurrent yield monetary assets, storing of the data related to these assets, sorting the data of these assets, and the communications between the rollup entity and an owner of the recurrent yield monetary assets. This description is not intended to limit the applicability of the present recurrent yield monetary asset based derivatives system to other system environments and is solely intended to provide a framework for the accompanying description of the present recurrent yield monetary asset based derivatives system.

FIG. 1 is a block diagram of a recurrent yield monetary asset based derivatives system 100 which comprises a rollup entity 102, a investment entity 120, and recurrent yield monetary asset owners 140A, 140B, and 140C. Rollup entity 102, investment entity 120, and recurrent yield monetary asset sources 140A, 140B, and 140C are coupled to one another and communicate through a network 150. Network 150 may comprise a plurality of communication lines 132. This is an illustration of a typical system architecture including several recurrent yield monetary asset resources 140A, 140B, and 140C. Recurrent yield monetary asset sources 140A and 140B are connected to the network 150 via an internal network or intranet 152. This is illustrated to show that several different recurrent yield monetary asset owners may be used with various connections, networks, and firewalls prior to the communication line 132 to the network 150. Additionally, a recurrent yield monetary asset based derivatives system 100 may include more or less recurrent yield monetary asset sources 140A, 140B, and 140C than illustrated. Furthermore, one investment entity 120 is shown in FIG. 1, however, the recurrent yield monetary asset based derivatives system 100 may include one or more investment entities 120.

Rollup entity 102 preferably includes one or more input devices, such as a keyboard 108 or a mouse 106, one or more output devices, such as a printer or a display 104 and a communication device, such as a modem 156. Further, rollup entity 102 preferably includes a server 110, a database 112, and an archive library 113. Server 110 may comprise a dedicated computer, with one or more processors, one or more input devices, one or more output devices, and one or more communication devices. Investment entity 120 preferably includes one or more input devices, such as a keyboard 124 or a mouse 122, one or more output devices, such as a printer or a display 128, a communication device, such as a modem 158, and a processor 126. Recurrent yield monetary asset source 140A preferably includes one or more input devices, such as a keyboard 146A or a mouse 148A, a communication device, such as a modem 160A, one or more output devices, such as a printer or a display 142A, and a processor 144A. Recurrent yield monetary asset resource 140B preferably includes one or more input devices, such as a keyboard 146B or a mouse 148B, a communication device, such as modem 162B, one or more output devices, such as a printer or a display 142B, and a processor 144B. Recurrent yield monetary asset resource 140C preferably includes one or more input devices, such as a keyboard 146C or a mouse 148C, a communication device, such as modem 164C, one or more output devices, such as a printer or a display 142C, and a processor 144C. Processor 144A, 144B, and 144C preferably further include either non-volatile memory or volatile memory or both.

Server 110 preferably comprises a mapping table. The mapping table may be a relational data structure that provides a correlation between an input and an output. Rollup entity 102 may further comprise one or more firewalls 154. In one embodiment, firewall 154 may be located between network 150 and server 110. Firewall 154 protects rollup entity 102 from both intentional and unintentional damage, which could pass through network 150. Firewall 154 may comprise hardware such as a computer with security measures, e.g., a dial-back feature, or may comprise defensive coding software. In general, firewall 154 receives data from network 150, determines whether the data could be harmful and, if not, transmits the data to server 110. In an alternative embodiment, one or more firewalls 154 may be placed between server 110 and database 112, between network 150 and server 110, between server 110 and archive 113, or in any other suitable location.

In general, the recurrent yield monetary asset based derivatives system 100 of the present invention allows a rollup entity 102 to communicate with recurrent yield monetary asset resources 140A, 140B, and 140C and to identify ones of such recurrent yield monetary asset resources 140A, 140B, and 140C that provide a recurring or constant monetary yield. Accordingly, the recurrent yield monetary asset resources 140A, 140B, and 140C provide information regarding their specific recurrent yield monetary asset to the recurrent yield monetary asset based derivatives system 100, which receives this information and determines whether they meet the desired criteria of the recurrent yield monetary asset based derivatives system 100. All of this may be accomplished in the convenient, non-intrusive environment of an on-line interaction and/or during telephone communications.

Rollup entity 102 communicates via communications lines 130, 132 with the recurrent yield monetary asset owners 140A, 140B, and 140C to identify viable recurrent yield monetary assets to acquire information related to the recurrent yield monetary assets. This information may include name, address, and type of recurrent yield monetary asset, account information, scalability, or any other information.

Communication lines 132 may be any type of communication link capable of supporting data transfer. In one embodiment, the communication lines 132 may comprise, alone or in combination, Integrated Services Digital Network (ISDN), Asymmetric Digital Subscriber Line (ADSL), T1 or T3 communication lines, hardwire lines, or telephone links. It will be understood that the communication lines 132 may comprise other suitable types of data communication links. Communication lines 132 may also connect to a plurality of intermediate servers between network 150 and rollup entity 102, recurrent yield monetary asset owners 140A, 140B, and 140C, and specific data criteria resource 120. Communications line 130 may be any type of telecommunications link capable of supporting voice transfer.

In one embodiment, the network 150 may comprise dial access via a telephone link. In this embodiment, rollup entity 102, recurrent yield monetary asset owners 140A, 140B, and 140C, and investment entity 120 may be remote from each other and located anywhere in the world. In one embodiment, rollup entity 102, recurrent yield monetary asset owners 140A, 140B, and 140C, and investment entity 120 may connect and communicate with each other via modems and analog or digital communication lines. Moreover, the network 150 may be any interconnection found on any computer network such as a local area network (LAN), a wide area network (WAN), the Internet, or any other communications and data exchange systems created by connecting two or more computers.

Preferably, the rollup entity 102 acquires investment entity 120 information by soliciting potential and known investment entities 120 over the phone using phone lines 130 or over the network 150. These investment entities 120 provide information to the rollup entity 102 regarding their performance and provide related information to the rollup entity 102 for later investment decisions by the rollup entity 102.

Preferably, rollup entity 102 further includes data processing capabilities to support various types of transactions which may be executed between the rollup entity 102 and the financial institution 202 and recurrent yield monetary asset resources 140A, 140B, and 140C. For example, the rollup entity 102 may acquire recurrent yield monetary assets 206A, 206B, and 206C from the recurrent yield monetary asset resources 140A, 140B, and 140C as part of a cash execution. The acquired recurrent yield monetary assets 206A, 206B, and 206C may, for example, be held as investments in rollup entity earnings account 210 of the financial institution 202 of the recurrent yield monetary asset based derivatives system 100. Alternatively, the rollup entity 102 may create recurrent yield monetary assets backed securities as part of execution, or create other financial instruments or assets that are collateralized by cash flows associated with individual recurrent yield monetary assets 206A, 206B, and 206C, including investments. Preferably, the rollup entity 102 may acquire a pool of recurrent yield monetary assets 206A, 206B, and 206C, securitize the pool of recurrent yield monetary assets 206A, 206B, and 206C to create recurrent yield monetary assets backed securities that are then sold to outside and public investors, and hold the pool of recurrent yield monetary assets 206A, 206B, and 206C in trust for the benefit of the investors. The rollup entity 102 may also receive a fee for guaranteeing to holders of recurrent yield monetary assets 206A, 206B, and 206C or other financial instruments the repayment of the recurrent yield monetary assets 206A, 206B, and 206C by recurrent yield monetary asset resources 140A, 140B, and 140C. The rollup entity 102 may also use recurrent yield monetary assets 206A, 206B, and 206C to create other types of financial assets or instruments, for example, by purchasing additional recurrent yield monetary assets 206A, 206B, and 206C and selling the financial instruments to investors, or by performing such services for other owners of recurrent yield monetary assets 206A, 206B, and 206C.

Preferably, rollup entity 102 includes acquisition capabilities usable to perform such operations as receiving information such as recurrent yield monetary assets 206A, 206B, and 206C information, interest rate, duration and characteristics of recurrent yield monetary assets 206A, 206B, and 206C and other parameters regarding recurrent yield monetary assets 206A, 206B, and 206C when recurrent yield monetary assets 206A, 206B, and 206C are first acquired and entered into the rollup entity 102. In the case of cash executions, the rollup entity 102 also performs such operations such as receiving commitments recurrent yield monetary asset resources 140A, 140B, and 140C.

Preferably, rollup entity 102 also processes periodic recurrent yield monetary assets 206A, 206B, and 206C data for accounting purposes and generates accounting output in connection with the acquired recurrent yield monetary assets 206A, 206B, and 206C. Preferably the rollup entity 102 performs such functions as receiving recurrent yield monetary assets 206A, 206B, and 206C data on an ongoing basis from investment entity 120. Preferably, the rollup entity 102 also includes additional functionality for servicing recurrent yield monetary assets 206A, 206B, and 206C. The accounting output generated by the rollup entity 102 may include such things as accounting, tax, performance/valuation, and/or other relevant financial information for the recurrent yield monetary assets 206A, 206B, and 206C acquired in the portfolio.

Preferably, the rollup entity 102 generates financial assets. Herein, the terms “financial asset generation” and “securitization” are used interchangeably and refer to any function that is used to generate/create financial assets. Herein, the term “financial asset” is used generically to refer to any asset that is backed by one or more cash flows, and includes such things as assets that are created entirely for internal data tracking purposes (e.g., in the case of packets which do not represent securities), as well as assets that have external significance (e.g., in the case of financial derivative instrument and securities). Preferably, the securitization function may be used to generate financial assets such as financial derivative instruments 204A, 204B, and 204C.

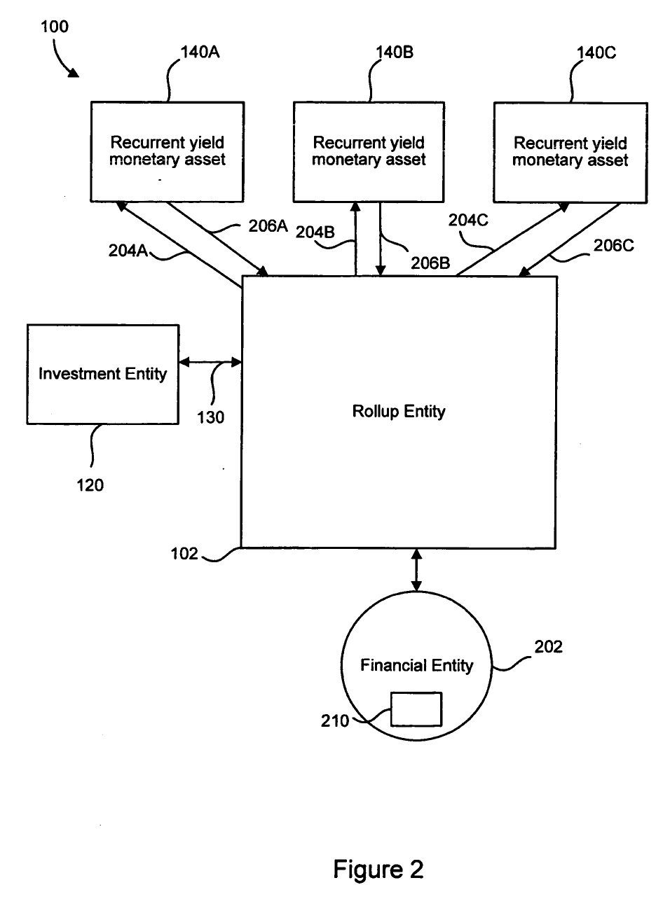

FIG. 2 is a block diagram of a recurrent yield monetary asset based derivatives system 100 that includes financial entity 202. Financial entity 202 is a financial institution, such as a bank, that assists with receiving and distributing the recurrent yield monetary asset resources 140A, 140B, and 140C, through a rollup entity earnings account 210, that are sent to the rollup entity 102 during operation. The financial entity 202 provides a facility to allow rollup entity 102 to create and maintain bank account information. The accounts are bank accounts established with the rollup entity 102 to facilitate issuance of financial derivative instruments 204A, 204B, and 204C. The rollup entity 102 has the ability to create/select/update its account information in real time, including account numbers and remittance/disbursement information. The information captured in this process allows the rollup entity 102 to create and execute financial derivative instruments 204A, 204B, and 204C transactions. Historical records of recurrent yield monetary assets 206A, 206B, and 206C account and draft information is maintained to assist in resolving any issues that may arise.

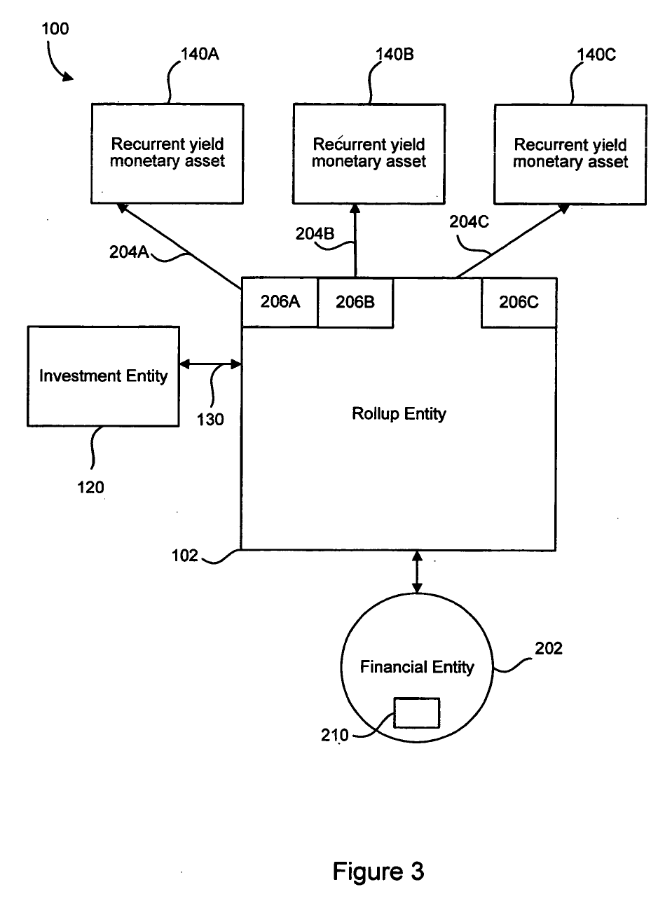

The recurrent yield monetary asset resources 140A, 140B, and 140C transfer recurrent yield monetary assets 206A, 206B, and 206C to rollup entity 102 via commonly known and utilized financial channels, such as financial institution wiring procedures. As described above, these recurrent yield monetary assets 206A, 206B, and 206C include royalties, salaries, royalty-type streams of revenue, and the like. The rollup entity 102 transfers financial derivative instruments 204A, 204B, and 204C to the recurrent yield monetary asset resources 140A, 140B, and 140C. FIG. 3 is a block diagram of the recurrent yield monetary asset based derivatives system 100 that depicting that the recurrent yield monetary assets 206A, 206B, and 206C have been transferred to the rollup entity 102. Additional recurrent yield monetary assets can be acquired to further the growth of the rollup entity 102.

Preferably, rollup entity 102 manages accounting activities associated with the acquisition of the recurrent yield monetary assets 206A, 206B, and 206C. The rollup entity 102 also provides a consistent methodology for the recording of accounting events related to business activities across the acquisition into subsidiary ledgers for posting to a general ledger. The rollup entity 102 preferably also performs and supports the accounting activities related to the packaging of cash flows precedent to securitization and issuance of financial derivative instruments 204A, 204B, and 204C. Preferably, rollup entity 102 performs the accounting activities related to forming securities out of acquired recurrent yield monetary assets 206A, 206B, and 206C.

The rollup entity 102 preferably journalizes recurrent yield monetary assets 206A, 206B, and 206C related business activity, maintains subsidiary ledgers, provides audit trails, provides data integrity and control within the subsidiary ledgers, facilitates timely reconciliations, provides flexibility to account for new products or changes depending on actual accounting methodologies, and provides information needed to perform financial analysis. When the journal entry is created, the appropriate debit/credit account numbers are first assigned to each of the acquired recurrent yield monetary assets 206A, 206B, and 206C as they are processed. The rollup entity 102 uses GAAP and commonly accepted business rules to automatically interpret the transactions.

The database 112 of rollup entity 102 preferably also stores and calculates extensive statistical information containing the entire universe of financial derivative instruments 204A, 204B, and 204C statistics in existence registered in the defined country or geographic area. This information includes rollup entity earnings account net asset value (N.A.V.) for each year, rollup entity earnings account composition, investment objective, load adjusted and unadjusted return, maximum sales charge, median market capitalization, daily, monthly, quarterly, yearly, multi-year returns, mpt, beta, sharpe, R squared, standard deviation, historical risk/reward ratios, N.A.V. distribution adjusted earning, payout ratio, potential capital gains exposure, price/book ratio, price/earnings ratio, prospectus, purchase constraints, redemption fees, sector weighting, shareholder fees, total return, total return percentile, turnover ratio, deferred fees, debt % total capitalization, dividends, distributor, telephone number, manager name, manager tenure, class of shares, and brokerage availability. It will be understood that not all of this information is required to practice the claimed invention.

In addition to the aforementioned aspects and embodiments of the present recurrent yield monetary asset based derivatives system 100, the present invention further includes methods for creating these recurrent yield monetary asset based financial derivative instruments. Generally, the recurrent yield monetary asset based derivatives system 100 communicates with the recurrent yield monetary asset resources 140A, 140B, and 140C to obtain recurrent yield monetary assets 206A, 206B, and 206C in exchange for financial derivative instruments 204A, 204B, and 204C.

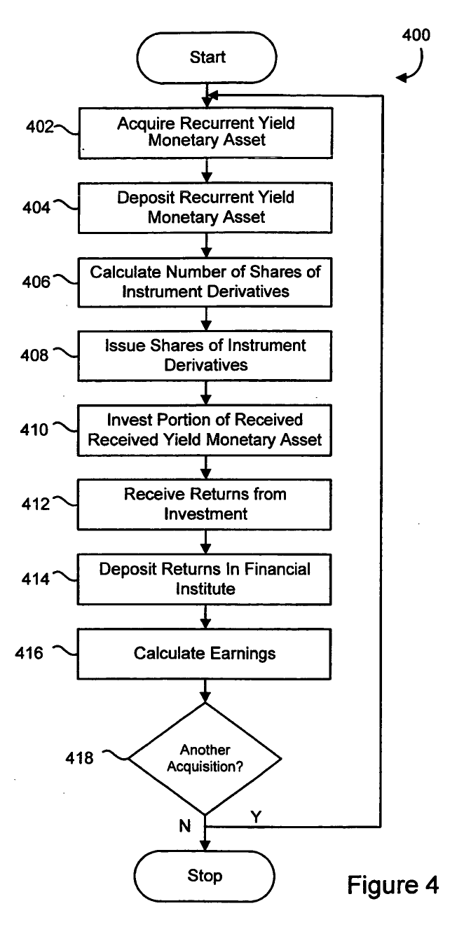

FIG. 4 illustrates an embodiment of a process 400 for a method for creating recurrent yield monetary asset based financial derivative instruments. In step 402, the rollup entity 102 initiates negotiations with the recurrent yield monetary asset resources 140A, 140B, and 140C. Though three recurrent yield monetary asset resources 140A, 140B, and 140C are depicted, the recurrent yield monetary asset based derivatives system 100 includes any number of recurrent yield monetary asset resources 140A, 140B, and 140C. In one aspect, the recurrent yield monetary asset based derivatives system 100 communicates with one or more recurrent yield monetary asset resources 140A, 140B, and 140C to negotiate the transfer of recurrent yield monetary assets 206A, 206B, and 206C. These communications can take place in the shape of negotiations regarding the amount of the recurrent yield monetary assets 206A, 206B, and 206C and the exchange of the financial derivative instruments 204A, 204B, and 204C of equal value. In one aspect of the present recurrent yield monetary asset based derivatives system 100, these communications take place in the form of telephone communications over communications line 130. In another aspect of the recurrent yield monetary asset based derivatives system 100, these communications take place via the Internet via communication lines 132. In addition, any combination of these two forms or additional commonly known and used forms of communication may be employed to facilitate these communications. During these communications, negotiations regarding the recurrent yield monetary assets 206A, 206B, and 206C and financial derivative instruments 204A, 204B, and 204C occur. In step 402, recurrent yield monetary asset based derivatives system 100 acquires recurrent yield monetary assets 206A, 206B, and 206C from recurrent yield monetary asset resources 140A, 140B, and 140C. This can involve one or a plurality of recurrent yield monetary assets 206A, 206B, and 206C.

In step 404, the recurrent yield monetary assets 206A, 206B, and 206C are transferred from the recurrent yield monetary asset resources 140A, 140B, and 140C to the rollup entity 102. This transfer of recurrent yield monetary assets 206A, 206B, and 206C is performed by all commonly known and used forms of financial transfers.

In step 406, the recurrent yield monetary assets 206A, 206B, and 206C are deposited in the financial institution 202 of the recurrent yield monetary asset based derivatives system 100. In one aspect of the present invention, the recurrent yield monetary assets 206A, 206B, and 206C are wire transferred to the financial institution 202. Other means of transfer commonly known and used in financial markets can also be employed. In another aspect, the recurrent yield monetary assets 206A, 206B, and 206C are deposited in a rollup entity earnings account 210 of the financial institution 202. In another aspect, the recurrent yield monetary assets 206A, 206B, and 206C are deposited into a private account of the rollup entity 102.

In step 408, the recurrent yield monetary asset based derivatives system 100 calculates the cash value, type of financial derivative instruments 204A, 204B, and 204C, and the number of shares to be exchanged and transferred to the recurrent yield monetary asset resources 140A, 140B, and 140C. This transfer can take place according to those practices and procedures commonly used in such arrangements. In one aspect, the rollup entity 102 calculates the present price of the stock shares to be issued by the rollup entity 102. In one aspect, this is done via a forward pricing.

Forward pricing unit may be implemented using a computer program or algorithm preferably stored on server 110 and executed by CPU's located therein, receives information from a data source, volatility calculator, and user interface device to determine the forward price or value (as a function of the price of the underlying recurrent yield monetary assets 206A, 206B, and 206C over time. Input devices are used to exchange information between the rollup entity 102 and financial institution 202. Depending on the commands to be implemented (e.g., forward price calculation, implied volatility calculation, option exercise, etc.), the information may include the observed market price of the underlying recurrent yield monetary assets 206A, 206B, and 206C, volatility (local, implied, etc.), interest rate (e.g., risk-free), maturity (e.g., expiration date), strike price, dividend yield, and other pertinent information.

Another aspect of valuing the price of the present financial derivative instruments 204A, 204B, and 204C is to calculate the present price-to-earnings multiple or ratio. The price-to-earnings (P/E) multiple compares the rollup entity 102 earnings with its share price. This is done by dividing the rollup entity 102 share price by the rollup entity 102 earnings per share. So, if the rollup entity 102 stock price is $100 and its quarterly earnings are $5 a share, then the present rollup entity 102 P/E multiple is 20. Other forms of this calculation can be used as well in calculating the present share price. For example, as the rollup entity 102 has stated P/E multiples that continue to grow, then the calculation can be run in reverse to calculate the price for the shares of the rollup entity. If the present P/E multiple is presently at 20, but the market impression of the rollup entity is that it will continue to have greater P/E multiples, then the price of the shares issued by the rollup entity 102 may be higher than $100 per share based on a believed higher P/E multiple.

In step 410, the calculated shares of the financial derivative instruments 204A, 204B, and 204C are issued to the recurrent yield monetary asset resources 140A, 140B, and 140C. As noted above, the issuance of these financial derivative instruments 204A, 204B, and 204C can be done in any commonly known or practiced method or means.

In step 412, the recurrent yield monetary assets 206A, 206B, and 206C that have been deposited with the rollup entity 102 or into the rollup entity earnings account 210, are invested in other financial markets, indexes, and instruments to further the growth of the rollup entity earnings account 210 of the rollup entity 102. In step 414, the return from the investments of step 412 are deposited into the rollup entity 102 or the rollup entity earnings account 210.

In step 416, the earnings are calculated by the recurrent yield monetary asset based derivatives system 100 for financial reporting or marketing of potential recurrent yield monetary asset resources 140A, 140B, and 140C. In step 418, the process is continued with additional recurrent yield monetary asset resources 140A, 140B, and 140C.

### PROPHETIC EXAMPLE

### Financial Derivative Instrument

A recurrent yield monetary asset resource 140A owns certain copyrighted music and receives an annual royalty stream of approximately $10,000,000. The recurrent yield monetary asset resource 140A agrees to transfer $4,000,000 per year of these royalties to the rollup entity 102. The rollup entity 102 deposits the $4,000,000 into the financial institution 202 and then issues $4,000,000 worth of financial derivative instruments 204A, in private stock with a face value of $100 per share, to the recurrent yield monetary asset resource 140A. At that time the annual earnings of the rollup entity 102 is $4,000,000.

Later a recurrent yield monetary asset resources 140B receives an annual guaranteed salary of $7,000,000 from playing professional baseball. The recurrent yield monetary asset resources 140B agrees to transfer $4,000,000 per year of his salary to the rollup entity 102. The rollup entity 102 deposits the $4,000,000 into the financial institution 202 and then issues $4,000,000 worth of financial derivative instruments 204B, in private stock with a face value of $100 per share, to the recurrent yield monetary asset resources 140B. The earnings have doubled from $4,000,000 to $8,000,000, yet the expenses are nominal, because there are no buyout costs involved that are commonly found with conventional rollups. Additionally, the investment entity 120 is utilized to further grow the present holdings of earnings so as to achieve an annual return on investment of approximately 7% to 15%, which is then added to the rollup entity 102 holdings.

After many additional acquisitions, the earnings are valued at $100,000,000 per year and the expenses continue to be nominal. Shares are then sold in the rollup entity 102 to the public which causes a large demand due to the increasing earnings and nominal related expenses, thus these public shares are traded at a premium and the price of all issued share increases accordingly.

Although there has been described what is at present considered to be the preferred embodiments of the present system and method for creating recurrent yield monetary asset based financial instruments derivatives, it will be understood that the system and method for creating recurrent yield monetary asset based financial instruments derivatives can be embodied in other specific forms without departing from the spirit or essential characteristics thereof. For example, additional recurrent yield monetary assets may be acquired other than those noted, such as any types of royalty streams from any types resources. The scope of the invention is indicated by the appended claims rather than the foregoing description.

1. A computer-implemented system for creating financial instrument derivatives based on recurrent yield monetary assets having an asset value from a recurrent yield monetary asset resource, comprising:
a rollup entity, said rollup entity comprising:
means for transferring from said recurrent yield monetary asset resource said at least one of said recurrent yield monetary assets;
means for depositing at least one of said recurrent yield monetary assets into a rollup entity earnings account;
means for calculating, responsive to depositing of said at least one recurrent yield monetary asset, at least one of the group consisting of a cash value and a number of shares of said financial instrument derivatives based on said asset value;
means for issuing said calculated number of shares of said financial derivative instruments to said at least one recurrent yield monetary asset resource;
database means located for storing information and data representative of said at least one recurrent yield monetary asset and said financial derivative instruments; and
means for communicating between said recurrent yield monetary asset resources and said rollup entity for transmitting said information and said data related to said at least one recurrent yield monetary asset.

2. The computer-implemented system of claim 1, wherein said rollup entity further comprises;
means for investing a portion of said rollup entity earnings account in a rollup entity investment.

3. The computer-implemented system of claim 1, wherein said communicating means is selected from the group consisting of world wide web, internet, intranet, and telephony.

4. The computer-implemented system of claim 1, wherein said communicating means further comprises:
an internet-enabled interface, the internet-enabled interface permitting said at least one recurrent yield monetary asset resource and said rollup entity to communicate to each other by way of the internet.

5. The computer-implemented system of claim 1, wherein said calculating means calculates a price to earnings multiple for said financial derivative instruments.

6. The computer-implemented system of claim 1, wherein said communicating means further comprises:
encrypted data transfer means for securely transmitting said information and said data between said recurrent yield monetary asset resource and said rollup entity.

7. A system for creating financial instrument derivatives based on recurrent yield monetary assets having an asset value from a recurrent yield monetary asset resource, comprising:
a rollup entity for receiving at least one of said recurrent yield monetary assets and issuing said financial instrument derivatives, said rollup entity comprising:
data processing means for calculating at least one of the group consisting of a cash value and a number of share of said financial instrument derivatives based on said asset value of said received at least one of said recurrent yield monetary assets;
storage means for storing data representative of said at least one recurrent yield monetary assets and said at least one of said financial instrument derivatives;
display means for presenting a display of said data;
input means for enabling input of said data into said storage means;
data transfer means for transmitting said data between said rollup entity and said recurrent yield monetary asset resource; and
communication means for communicating between said recurrent yield monetary asset resources and said rollup entity for transmitting said information and said data related to said at least one recurrent yield monetary asset.

8. The system for creating financial instrument derivatives of claim 7, further comprising:
means for depositing at least one of said recurrent yield money assets into a rollup entity earnings account.

9. The system for creating financial instrument derivatives of claim 8, further comprising:
means for investing a portion of said rollup entity earnings account in a rollup entity investment.

10. The system for creating financial instrument derivatives of claim 8, wherein said communicating means is selected from the group consisting of world wide web, internet, intranet, and telephony.

11. A computer-implemented method for creating recurrent yield monetary asset based financial instrument derivatives by a rollup entity in communication with at least one recurrent yield monetary asset resource, said recurrent yield monetary asset having an asset value, said method comprising:
communicating between said rollup entity and said at least one recurrent yield monetary asset resource regarding acquiring an at least one recurrent yield monetary asset;
transferring from said at least one recurrent yield monetary asset resource to said rollup entity said recurrent yield monetary asset;
depositing said one recurrent yield monetary asset into a rollup entity earnings account;
calculating at least one of the group consisting of a cash value and a number of shares of said financial instrument derivatives based on said asset value; and
issuing from said rollup entity to said at least one recurrent yield monetary asset resource said calculated number of shares of said financial derivative instrument.

12. The method for creating financial instrument derivatives of claim 11, further comprising:
investing at least a portion of said rollup entity earnings account in a rollup entity investment.

13. The method for creating financial investment derivatives of claim 11, wherein said communicating is selected from the group consisting of World Wide Web, Internet, intranet, and telephony.

14. The method for creating financial instrument derivatives of claim 11, wherein said communicating comprises:
providing an internet-enabled interface, the internet-enabled interface permitting said at least one recurrent yield monetary asset resource to access the method by way of the Internet.

15. The method for creating financial instrument derivatives of claim 11, further comprising:
calculating a price to earnings multiple for said financial derivative instruments.

16. The method for creating financial instrument derivatives of claim 11, further comprising:
electronically processing said stored information to determine in real time the price of said financial derivative instruments on the basis of a system-defined method of weighting a portfolio of financial derivative instruments.

17. The method for creating financial instrument derivatives of claim 11, further comprising:
outputting an indication of the determined in real time price of the financial derivative instruments in readable format.

18. The method for creating financial investment derivatives of claim 11, further comprising:
issuing financial instruments to non-recurrent yield monetary based asset resources.

19. The method for creating financial instrument derivatives of claim 11, further comprising:
listing outstanding shares of the financial derivative instruments on an exchange.

20. The method for creating financial instrument derivatives of claim 11, further comprising:
correlating the price of the outstanding shares to the price of the financial derivative instruments.
